(19) United States
(12) Patent Application Publication
(10) Pub. No.: US 2014/0352621 A1
(43) Pub. Date: Dec. 4, 2014

(54) Combination Storage, Dispensing and Feeding Device for Domestic Animals

(71) Applicant: Putnam R. Fairbanks, Thousand Oaks, CA (US)

(72) Inventor: Putnam R. Fairbanks, Thousand Oaks, CA (US)

(21) Appl. No.: 13/909,066

(22) Filed: Jun. 3, 2013

(51) Int. Cl. A01K 5/01

(52) U.S. Cl. CPC A01K 5/0128; A01K 5/0142
USPC 119/61.53; 119/61.5

(57) ABSTRACT

A pet feeding device is disclosed having an outer container, an inner cavity within said container, a retaining ridge at the mouth of the inner cavity, a stacked array of at least one liner, and a compression device. The at least one liner can be nested within the inner cavity and then be individually disposed of as required for each new feeding. The at least one liner is held in the inner cavity by the retaining ridge and the compression device. The at least one liner is placed into device for restocking by pressing down into the inner cavity. The at least one liner can be removed for disposal individually. The compression device in bottom of cavity supports liners and continuously keeps supply of the at least one liner conveniently staged at top edge of cavity, as well as keeps them from moving during feedings.

### PRIORITY CLAIM

This patent application is a continuation-in-part of copending, non-provisional patent application U.S. patent application Ser. No. 12/930,982 by Fairbanks, filed on Jan. 21, 2011, entitled COMBINATION STORAGE, DISPENSING AND FEEDING DEVICE FOR DOMESTIC ANIMALS. This patent application also claims benefit of the priority date of U.S. Prov. Pat. App. Ser. No. 61/396,236 by Fairbanks, filed on May 24, 2010, entitled COMBINATION STORAGE, DISPENSING AND FEEDING DEVICE FOR DOMESTIC ANIMALS. The contents of both referenced applications are hereby incorporated in their entirety by reference.

### FIELD OF THE INVENTION

The present invention generally relates to food bowls. More specifically, the present invention relates to food bowls having disposable liners for serving food to pets, wherein the disposable liners reduce the need to wash the food bowl.

### BACKGROUND OF THE INVENTION

Traditionally pet owners and other keepers of animals have been faced with the problem of regularly maintaining the sanitation of dishes, plates and bowls in which they serve food for their domestic animals. More specifically, the ‘wet’ foods they serve have the stubborn propensity to stick to the feeding surface like glue, in between feedings. Cleaning these surfaces has always been an onerous process. Industry has recognized this frustration and responded by creating countless ‘dry’ products which are essentially pelletized grains with flavoring added. Unfortunately these products deprive the animals of dietary variety, nutrition, or both. As an example, at are recognized by biologists, and described by them, as Obligate Carnivores. They must eat whole food as they would in the wild for, among other reasons, that is their primary source of liquids. Over the years individuals have recognized the above shortcomings and have attempted different solutions to provide disposable feeding surfaces that would remove the burden of daily cleaning of food dishes.

The interest in developing a combination dispenser of disposable inserts and a feeding platform for domestic animals has been with us for quite a few years. Many individuals have contributed to the evolution of such a device; however the latest, most advanced and evolved solutions to all the design ideals one might ask for are found in U.S. Pat. No. 7,441,514 and U.S. Pat. No. 7,392,761.

U.S. Pat. No. 7,441,514 proposes the usual combination of outer dish with inserts or liners. The main body of the inserts is nested within the dish. The inserts, however, have outwardly extending flanges at their top so that when inserts are nested within the dish, their flanges rest atop of, outside of, and are supported by the exterior wall of the dish. Because of this arrangement the inventors then have to resort to an external means to secure the inserts to the outer dish. Towards that end they have proposed a series of movable and unmovable retaining elements to trap inserts in place. These are external add-ons to the outer dish. Two of the retaining elements are simply ‘stops’ that limit lateral movement of the inserts. While these two elements restrain gross lateral movement of the inserts, the inventors recognized they would not stop inserts from spinning during feeding. The third retaining element, therefore, has a clasping function and added “anti-spin” prongs to keep the inserts from spinning within the outer dish. While that seems useful, a major latent flaw in this design is that it fails to provide adequate means for its retaining elements to successfully retain a stack of inserts that is always changing in height every time a used liner is discarded. The same clamps and anti-spin prongs that retain a large number of inserts in position will not be equally successful in retaining a single insert in position without added provisions. Those provisions are conspicuously not to be found in their patent.

As will be seen, this design is vastly more complicated than it needs to be, and vastly more complicated than the device disclosed by the present patent application. The inventor requires 8 pages of drawings and more than 60 views and images to adequately capture all the complexities of the design. A full 18 of the inventor's 20 claims are devoted simply to the design of the retaining elements alone. The present patent application will show that none of this is necessary. The compressive device supporting the liners against the retaining lip detailed in the present application holds any number of liners firmly in place without any movement. Complexity adds increased manufacturing burden and prohibitive costs.

Not on is complexity a manufacturing and cost negativity in this design, but the moving parts used herein will always have a greater propensity for failure than static or non-moving parts. Another liability of this device is the added complication, dexterity, and effort required of user in having to mechanically disengage and then engage retaining element each and every time a liner needs to be disposed of. Still another fault of this device is that the uppermost edges of all the inserts lay atop and outside of the outer dish, and will always be susceptible of food spillage and contamination from previous feedings. That raises serious sanitation and aesthetic concerns.

The last flaw uncovered by a careful reading of this patent is that the inventor declares it is a primary objective of his design to accept conventional, readily available liners from a number of pre-existing supply sources. That means that the success or failure of his device will always be subject to the design and configuration of presently available liners and the whim of those who supply them. Unfortunately that limitation precludes all kinds of possible other designs imagined by the manufacturer of the device proposed in the present patent application.

U.S. Pat. No. 7,392,761 discloses a pet dish apparatus that includes a spring loaded retaining base, within which sits a permanent liner-positioning bowl. Disposable inserts are to be nested in this inner bowl and a ring-like rim hinge and latch on top of the base unit is necessary in order to keep inner bowl and inserts in place within retaining base. While the introduction of a spring loaded base suggests an advancement on the prior art, it falls short. Too many of the other features presented herein detract from the invention's overall effectiveness and financial viability.

As with the previously discussed patent, the externally added hinge, latch and retaining ring all add needless complexity and cost to the manufacturing, marketing, mass acceptance and even use of this invention. Again, there is the same need here for the user to each and every time disengage a latch, and lift hinged rim at every feeding in order to dispose of each used insert. Again, the same need to then reposition rim and re-engage lock is wearisome and adds needless dexterity and effort to the use of the device.

The insistence upon a spring of uniform pitch from base to its top in order to support inserts again adds more engineering and manufacturing complexity, as well as needless costs. The present patent application suggests that a simple piece of rubberized loam accomplishes the same effect without all of the drawbacks.

Still another flaw, the inclusion of a permanent bowl within the outer bowl, to be used as a necessary means to keep disposable inserts horizontally aligned to the outer retaining base, is another claim that makes no engineering, commercial or practical sense. It only hurts the viability of the product. Not only that it fails by its own design. Drawings show the inventor proposed an inner tapered permanent bowl residing inside of a larger tapered retaining base. As inserts are used and discarded, and as the spring loaded permanent bowl begins to arise accordingly, the tapered match between the permanent bowl and the retaining base is totally lost. Along with it, the lateral stability between the permanent bowl with inserts, and the retaining base envisioned by the inventor, is equally lost. That is why car engine cylinders and pistons are specifically designed with matching straight shafts.

Finally, this invention calls for extraction tabs on each of the disposable inserts in order to aid removal of used inserts. This only adds more manufacturing complexity and cost. The device proposed by the present patent application requires only a simple, no-cost thumb notch in the outer dish to allow simple peeling off of the used inserts.

### SUMMARY OF THE INVENTION

in view of the foregoing disadvantages inherent in the known types of pet feeding dishes represented by the prior art, the invention in the present application seeks to create an improved pet feeding device. This device will have many of the advantages of the pet feeding dishes disclosed heretofore as well as novel features that remove disadvantages of previous inventions and result in a pet feeding system which is not anticipated, rendered obvious, suggested, or even implied by any of the prior art, either alone or in any combination thereof.

The present invention is directed to a pet feeding device having an outer container that has a bottom, walls, upper periphery, an inner cavity confined by its walls, and a retaining lip extending inwardly near the top of upper periphery. The outer container is configured to accommodate at least one liner stacked in a vertical array. Each of the at least one liner has an inner surface, an outer surface, and an upper periphery. The at least one liner is positioned and nested within the inner cavity of the outer container and confineable in a horizontal position by the inner walls. Finally, a compression device is positionable within the inner cavity below the at least one liner and upwardly presses the at least one liner against the retaining lip.

There has thus been outlined, rather broadly, the more important features of the invention in order that the detailed description that follows may be bettor understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concepts, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These, as well as other advantages of the present invention will be more apparent from the following description and drawings. It is understood that changes in the specific structure shown and described may be made within the scope of the claims, without departing from the spirit of the invention.

It is the goal and object of present invention to provide a new net feeding device which will be recognized for its minimal cost, and maximum convenience, simplicity and user friendliness. It will require an absolute minimum of dexterity and wasted movement or effort to operate.

It is a further object of the present invention to provide a new pet feeding device which is of a durable and reliable construction, with no moving parts or other unnecessary structural complexities that add extra cost, add risk of mechanical failure, or require added dexterity and manipulation by user.

A still further object of the present invention is to provide a new pet feeding device which is of lowest possible cost to manufacture, both in regard to engineering as well as materials and labor. In so doing the device would accordingly be then susceptible of lower sales price, and thus make it more readily and economically available to the widest segment of the buying public.

In summary, it is the goal and object of present invention to provide a new pet feeding device which will be recognized for its minimal cost, and maximum convenience, simplicity and user friendliness. It will require an absolute minimum of dexterity and wasted movement or effort to operate.

It is a further object of the present invention to provide a new pet feeding device which is of a durable and reliable construction, with no moving parts or other unnecessary structural complexities that add extra cost, add risk of mechanical failure, or require added dexterity and manipulation by user.

A still further object of the present invention is to provide a new pet feeding device which is of lowest possible cost to manufacture, both in regard to engineering as well as materials and labor. In so doing the device would accordingly be then susceptible of lower sales price, and thus make it more readily and economically available to the widest segment of the buying public. More specifically the present invention is directed to:
(a) The operation of device proposed herein represents a huge jump in ease and simplicity over competing devices previously referenced herein. Those devices all entail a four step process of releasing latches, opening retaining elements, removing a liner, and then reclosing all this same hardware. The invention disclosed herein is a one step process, identical in simplicity and ease of use to peeling a sheet of paper from a pad.
(b) Design of current device is ultra simple and obviates the need to engineer and develop separate retaining elements, hinges, latches, and anti-spin hardware required by earlier inventions.
(c) Design of current device also does away with the entirely separate design and development effort required to then secure all retention hardware to outer bowl of earlier patents.
(d) The device disclosed herein represents a huge manufacturing advantage over previous devices. Outer container and retaining lip are easily manufactured in a single step. In preferred embodiment of device proposed herein, retaining lip is cast and built into outer container in same process as rest of said container. No separate efforts or costs are required for making this integral retaining lip. Previous inventions require their retaining elements be built separately and then separately added to outer container. Compressive device may be easily cut from standard, cheap, widely available 1″ foam rubber.
(e) Because of markedly more simple design and manufacturing efforts required by new device detailed herein, said device must necessarily be cheaper to fabricate. As a consequence of fewer manufacturing costs associated with new design disclosed herein, this invention can be marketed and sold at a price more favorable to consumers and the mass market. It thereby will bring improved dietary choices to a larger segment of the domestic animal population.
(f) By eliminating moving parts suggested in previous patents, the design presented herein will not be subject to breakage or dysfunction, through wear or improper usage, which previous designs may be susceptible to. This speaks to greater reliability and longevity of the device proposed in this application.

While the apparatus has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the preferred embodiment of a pet feeding device having disposable liners;

FIG. 2 is an exploded perspective view of the pet feeding device;

FIG. 3 is a cross-section side view of the pet feeding device;

FIG. 4 is a cross-section side view of an outer container detailing the preferred configuration of a retaining ridge;

FIG. 5 is a perspective view of a disposable liner;

FIG. 6 is a cross-section side view of the outer container in an alternative embodiment of the pet feeding device featuring a base groove;

FIG. 7 is a perspective view of another alternative embodiment of the pet feeding device featuring a detachable rim; and

FIG. 8 is a side view of the alternative embodiment of the pet feeding device illustrated in FIG. 7.

### DESCRIPTION OF THE PREFERRED EMBODIMENT

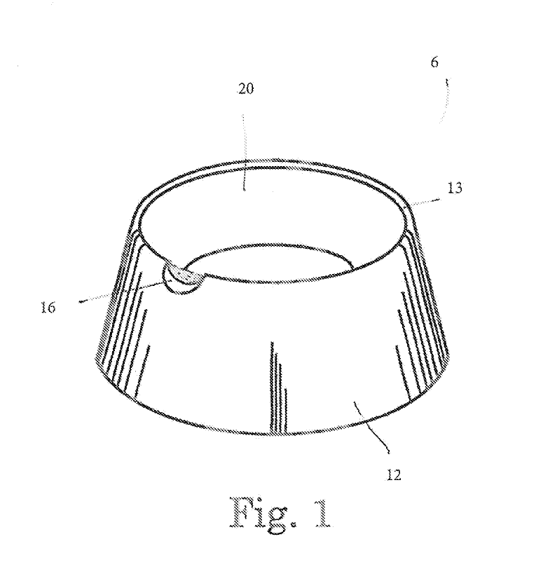

With reference now to the drawings, FIG. 1 illustrates a pet feeding device 10 in a preferred embodiment. The pet feeding device 10 generally has an outer container 12 having a retaining ridge 13 in a top aspect. At least one liner 20 is shown to be disposed into the outer container 12. A thumb notch 16 is formed out of the outer container 12 and the retaining ridge 13 to facilitate removal of the at least one liner 20.

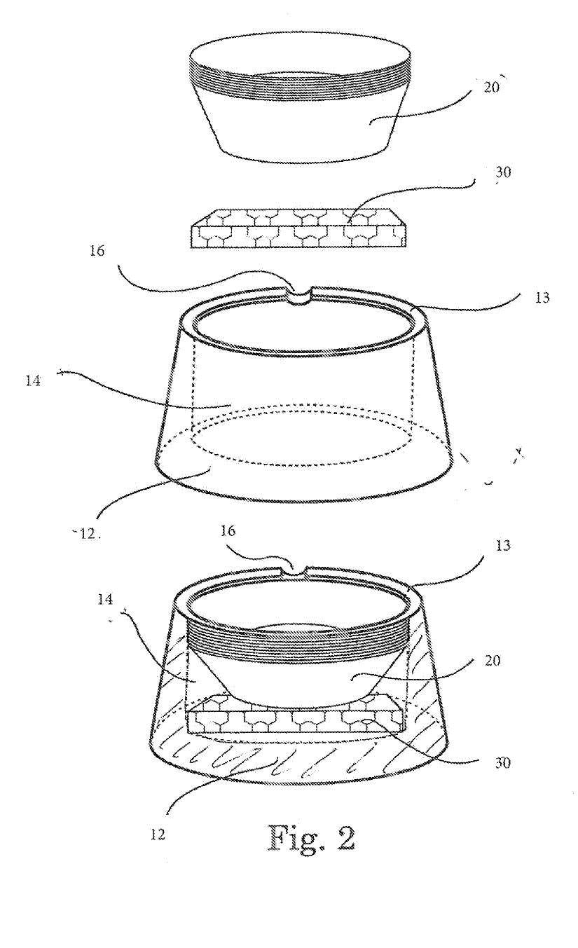

Regarding FIG. 2, an exploded view of the pet feeding device 10 is shown. The at least one liner 20 is preferably a stacked vertical array of liners. A compression device 30 is configured underneath the at least one liner 20 to provide for a resilient yet pliable material capable in pushing the at least one liner 20 in an upward direction.

The outer container 12 has an inner surface, an outer surface, a solid bottom and an upper periphery. In a preferred embodiment, the outer container 12 is substantially circular with curved edges. Other configurations as to shape or size are not outside the scope of the present invention, such as a square outer container 12 with hard edges. An inner cavity 14 is partially confined and defined by the inner surface. The inner cavity 14 is preferably shaped to generally be cylindrical but can alternatively resemble any other three dimensional shape such as a rectangular prism or a cube.

The retaining ridge 13 is configured on the upper periphery and extends the outer container 12 slightly inward to form a slight overhang above the inner cavity 14. In a preferred embodiment, the retaining ridge 13 is fixed in position by being molded or formed into the outer container 12. The retaining ridge 13 is designed to prevent slippage or movement of the at least one liner 20 once disposed in the inner cavity 14. The at least one liner 20 can be easily removed from the inner cavity 14 because the retaining ridge 13 is configured to only prevent accidental or unintentional movement but allow intentional removal.

The compression device 30 may be of any substance, structure or design that when compressed or deflected will seek to return to its original state and position by exerting an opposite pressure against the force causing the compression or deflection. Such materials include springs, living hinges, foams, rubber devices, elastics and inflated devices. The opposite pressure facilitates the upward press required to prevent movement or spinning of the at least one liner 20. In a preferred embodiment, the compression device 30 is a block of foam rubber.

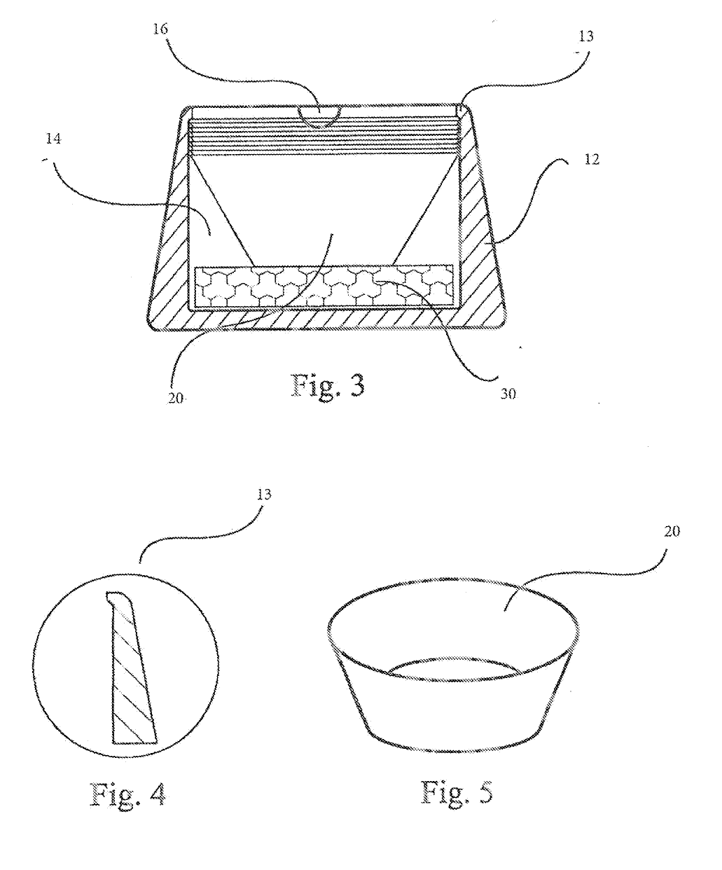

FIG. 3 is a side, cross-sectional view of the pet feeding device 10 wherein the at least one liner 20 and the compression device 30 have been placed within the inner cavity 14. The compression device 30 upwardly presses the at least one liner 20 causing the at least one liner 20 to be pressed into the retaining ridge 13. The compression device 30 and the retaining ridge 13, in conjunction, cause the at least one liner 20 to be held into place by horizontally aligning the at least one liner 20 to the retaining ridge 13.

The at least one liner 20 has an upper rim, an intermediate section and a base bottom. The at least one liner 20 is also preferably shaped to be a cylindrical trapezoid wherein the upper rim and the base bottom are substantially circular. The upper rim has a diameter larger than the base bottom to have the intermediate section form a dish for placement of pet food. The retaining ridge 13 is substantially similar in circumference as the upper rim of the at least one liner 20 to securely hold the at least one liner 20 in place.

In the event that the at least one liner 20 is no longer present in the inner cavity 14, another at least one liner 20 can be disposed by pressing the at least one liner 20 into the inner cavity 14 causing a depression or deformation of the compression device 30. The at least one liner 20 would then pass the retaining ridge 13 to allow for the retaining ridge 13 to then secure the at least one liner 20.

FIG. 4 exemplifies the retaining ridge 13 in a cross-sectional view. The retaining ridge 13 is configured to have a slight overhang over the inner cavity 14 to retain the at least one liner 20. FIG. 5 depicts the at least one liner 20 standing apart from the pet feeding device 10 in a perspective view. While the at least one liner 20 is preferably a cylindrical trapezoid as described above, it may be of any three dimensional shape such as a cube or rectangular prism with hard or rounded edges depending on the desired aesthetics. Each of the at least one liner 20 is of substantially the same configuration allowing for easily stacking them in a vertical array. The at least one liner 20 is preferably constructed of a material that is resilient yet pliable configured to hold wet foods, dry foods or liquids without disrupting or affecting unused liners.

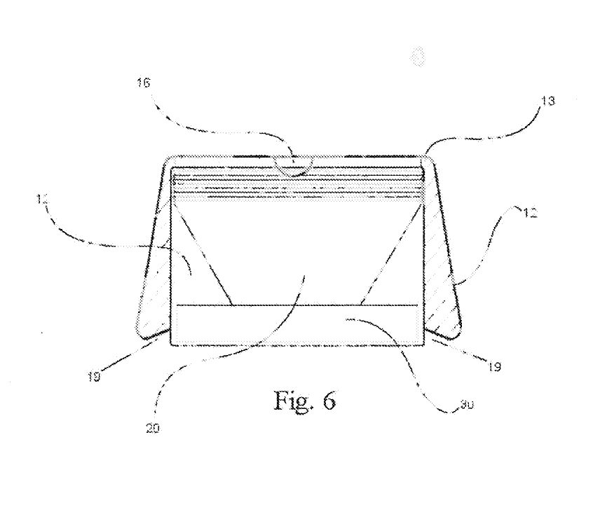

FIG. 6 illustrates an alternative embodiment of the pet feeding device 10. In this embodiment, the outer container 12 features a base groove 19 along a bottom side. Preferably, the base groove 19 circumscribes an outer edge of the bottom side of the outer container 12 without affecting the inner cavity 14. A substance may be disposed in the base groove 19 for a variety of purposes. For example, an insect repellent may be disposed in the base groove 19 to repel insects from getting into the pet feeding device 10. Petroleum jelly may also be disposed in the base groove 19 to cause insects to not enter the pet feeding device 10. The petroleum jelly is known in the art to impede movement of insects.

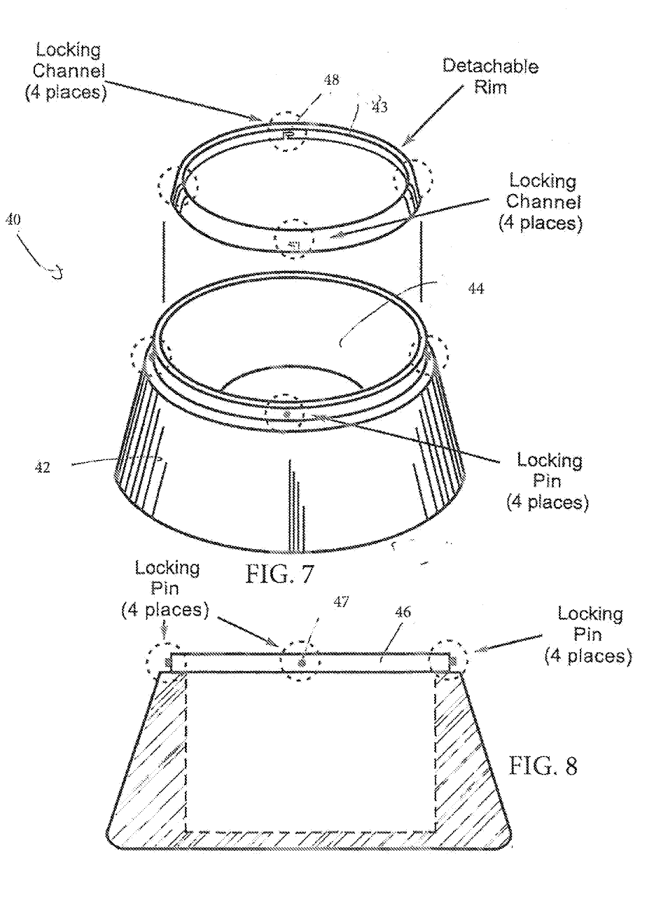

An alternative embodiment is depicted in FIG. 7 and FIG. 8, wherein the outer container 12 now has a detachable retaining ridge 43 (FIG. 7) instead of the fixed retaining ridge 13 (FIG. 1). The detachable retaining ridge 43 has a plurality of locking channels 48 preferably shaped like an ‘L’ character. The plurality of locking channels 48 corresponds to a plurality of locking pins 47 located on the outer container 12. When the detachable retaining ridge 43 is locked onto the outer container 12 by mating the plurality of locking channels 48 and the plurality of locking pins 47, the detachable retaining ridge 43 would be locked into place to prevent accidental removal. The detachable retaining ridge 43 has an inner circumference that is substantially similar to the upper rim of the at least one liner 20 to provide a secure position preventing the at least one liner 20 from inadvertently being removed from the inner cavity 14.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

While the particular Combination Storage, Dispensing and Feeding Device as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

I claim:

1. A pet feeding device, comprising:
an outer container, comprising an inner cavity and a retaining ridge;
a compression device, wherein the compression device is configured within the inner cavity; and
at least one liner stacked therein in a vertical array,
wherein the at least one liner is containable within the inner cavity and supported by the compression device,
wherein the at least one liner is confineable in the inner cavity by the retaining ridge.

2. The pet feeding device of claim 1, wherein the retaining ridge further comprises a plurality of locking channels and is detachable from the outer container.

3. The pet feeding device of claim 2, wherein the plurality of locking channels further comprise a right angle to require a rotating motion to detach the retaining ridge.

4. The pet feeding device of claim 2, wherein the outer container further comprises a plurality of locking pins configured to couple to the locking channels of the retaining ridge to lock the retaining ridge into a fixed position.

5. The pet feeding device of claim 1, wherein the bowl is made of a rigid material selected from the group consisting of metal, hard plastic, ceramic, wood, and definable forms.

6. The pet feeding device of claim 1, wherein the outer container further comprises a base groove formed on a bottom side of the outer container, wherein the base groove is circumscribed along an outer edge of the bottom side.

7. The pet feeding device of claim 6, wherein the bottom side is lower than a bottom edge of the outer container.

8. The pet feeding device of claim 6, wherein a substance is disposed in the base groove.

9. The pet feeding device of claim 8, wherein the substance is an insect repellant to prevent insects from approaching the pet feeding device.

10. The pet feeding device of claim 8, wherein the substance is petroleum jelly to prevent insects from climbing into the pet feeding device by way of the base groove.

11. The pet feeding device of claim 1, wherein the at least one liner has an upper circumference, and the retaining ridge has a circumference, wherein the circumference of the at least one liner is configured to be substantially similar to the circumference of the retaining ridge.

12. A method of providing food to an animal, comprising the steps of:
providing an outer container, comprising an inner cavity, a detachable retaining ridge, a compression device, wherein the detachable retaining ridge comprises a plurality of locking channels, wherein the detachable retaining ridge is along a top edge of the inner cavity, wherein the compression device is disposed within the inner cavity;
providing a first set of at least one liner;
inserting the first set of at least one liner into the inner cavity to compress the compression device; and
placing food on top of the first set of at least one liner.

13. The method of claim 12, further comprising the step of removing one of the at least one liner from the outer container.

14. The method of claim 12, further comprising the step of detaching the detachable retaining ridge from the outer container.

15. The method of claim 13, further comprising the steps of:
providing a second set of at least one liner when the last liner of the first set of at least one liner is removed from the outer container; and
inserting the second set of at least one liner into the inner cavity to compress the compression device.

16. The method of claim 12, wherein the outer container further comprises a base groove formed on a bottom side of the outer container, wherein the base groove is circumscribed along an outer edge of the bottom side.

17. The method of claim 16, further comprising the step of disposing a substance in the base groove.

18. The method of claim 17, wherein the substance is an insect repellant to prevent insects from approaching the pet feeding device.

19. The method of claim 17, wherein the substance is petroleum jolly to prevent insects from climbing into the pet feeding device by way of the base groove.

20. An apparatus for providing food, comprising:
a bowl with a retaining ridge around the periphery of a cavity, wherein the retaining ridge is detachable from the bowl;
a base groove along an underside of the bowl; and
at least one liner upwardly pressable against said retaining ridge by a compression device.
